(19) United States
(12) Patent Application Publication
(10) Pub. No.: US 2025/0070660 A1
(43) Pub. Date: Feb. 27, 2025

(54) SWITCH CAPACITOR CHARGING CIRCUIT

(71) Applicant: Nanjing Silergy Micro Technology Co., Ltd., Nanjing (CN)

(72) Inventor: Lang Mao, Nanjing (CN)

(21) Appl. No.: 18/811,892

(22) Filed: Aug. 22, 2024

(30) Foreign Application Priority Data
Aug. 23, 2023 (CN) 202311071681.6
Aug. 19, 2024 (CN) 202411139638.3

(51) Int. Cl. H02M 3/07; H02J 7/00

(52) U.S. Cl. CPC H02M 3/07; H02J 7/0034; H02J 2207/20

(57) ABSTRACT

A switch capacitor charging circuit can include: a first port coupled to a first voltage source; a second port coupled to a first battery; a switch capacitor circuit including (N−1) switch capacitor units coupled between the first port and the second port, and being configured to charge the first battery, where each of the switch capacitor units includes a flying capacitor; at least one first power transistor, where each first power transistor includes a first terminal coupled to the first port, and a second terminal coupled to one terminal of a flying capacitor in a different switch capacitor unit; and where the first switch capacitor unit is coupled to the second port, and an (N−1)-th switch capacitor unit is configured to be coupled to the first port, where N is a positive integer greater than or equal to 3.

### RELATED APPLICATIONS

This application claims the benefit of Chinese Patent Application No. 202311071681.6, filed on Aug. 23, 2023, and also claims the benefit of Chinese Patent Application No. 202411139638.3, filed on Aug. 19, 2024, both of which are incorporated herein by reference in their entirety.

### FIELD OF THE INVENTION

The present invention generally relates to the field of power electronics, and more particularly to switching capacitor charging circuits.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic block diagram of an example switch capacitor charging circuit.

FIG. 2 is a schematic block diagram of a first example switch capacitor charging circuit, in accordance with embodiments of the present invention.

FIGS. 3A and 3B are equivalent circuit diagrams of the first example switch capacitor charging circuit with a first operation manner in different operation stages in the second mode, in accordance with embodiments of the present invention.

FIGS. 4A and 4B are equivalent circuit diagrams of the first example switch capacitor charging circuit with a second operation manner in different operation stages in the second mode, in accordance with embodiments of the present invention.

FIG. 5 is a schematic block diagram of a second example switch capacitor charging circuit, in accordance with embodiments of the present invention.

FIG. 6 is a schematic block diagram of a third example switch capacitor charging circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

With the widespread use of terminal devices such as mobile phones, tablets, and Bluetooth headsets, higher requirements have been placed on charging efficiency. Compared with traditional converter topology, switch capacitor circuits (e.g., charge pumps) are widely used in mainstream fast charging solutions because of their ultra-high efficiency.

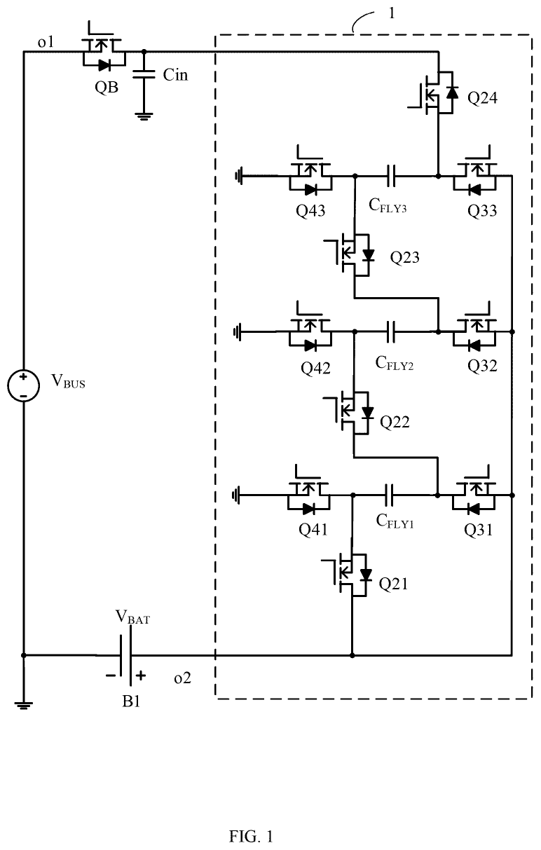

At present, a fast charging scheme of a high-power single battery can be realized by switch capacitor converters with a voltage conversion ratio of an input voltage and an output voltage compatible with 4:1 and 2:1. When a switch capacitor converter with a voltage conversion ratio of 4:1 is used, a voltage conversion ratio of 2:1 can be simultaneously supported by topology transformation. Referring now to FIG. 1, shown is a schematic block diagram of an example switch capacitor charging circuit. The switch capacitor charging circuit can include a switch capacitor converter. When the voltage conversion ratio of the input voltage and the output voltage is 4:1, power transistors Q21, Q22, Q23, Q24, Q31, Q41, Q32, Q42, Q33, and Q43, and flying capacitors C_{FIY1}, C_{FIY2}, and C_{FIY3} may all be enabled to operate, thereby forming a switch capacitor converter with the voltage conversion ratio of 4:1. When the voltage conversion ratio of the input voltage and the output voltage is 2:1, power transistors Q23, Q24, Q33, and Q43, and flying capacitor C_{FIY3} may all be enabled to operate, and power transistor Q32 may remain on, thereby forming a switch capacitor converter with the voltage conversion ratio of 2:1.

In this way, although the voltage conversion ratio of the input voltage and the output voltage is switched between 4:1 and 2:1, when the voltage conversion ratio is 2:1, only the power transistors near a high voltage side of voltage source V_{BUS} may be controlled to operate, which can lower the efficiency of the switch capacitor charging circuit.

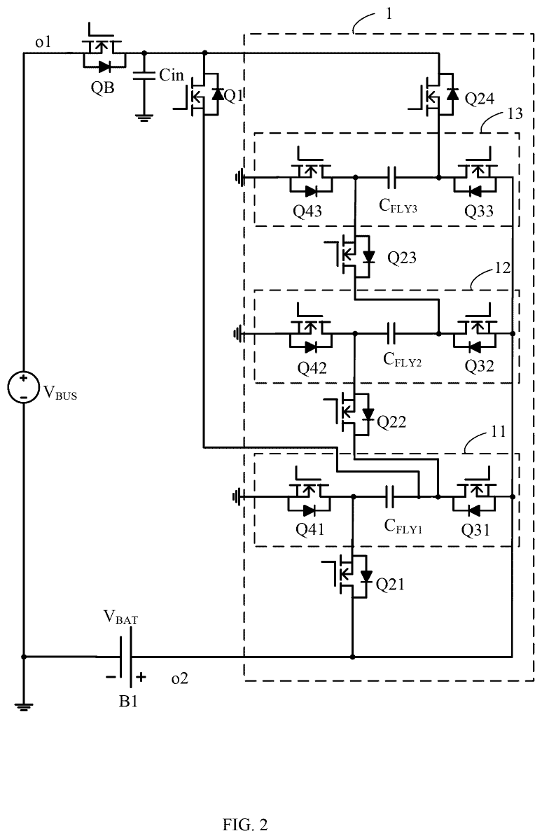

Referring now to FIG. 2, shown is a schematic block diagram of a first example switch capacitor charging circuit, in accordance with embodiments of the present invention. In this particular example, the switch capacitor charging circuit can include port o1, port o2, and switch capacitor circuit 1. Port o1 can connect to voltage source V_{BUS} and switch capacitor circuit 1. Port o2 can connect to a first terminal of battery B1, and a second terminal of battery B1 can connect to a ground terminal. In this example, switch capacitor circuit 1 can be configured as a switch capacitor converter.

Switch capacitor circuit 1 can include N−1 switch capacitor units coupled between port o2 and port o1. Switch capacitor circuit 1 can charge battery B1, and a (N−1)-th switch capacitor unit may be coupled to port o1; that is, close to a high-voltage side of first voltage source V_{BUS}. A first switch capacitor unit can be close to a low-voltage side of first voltage source V_{BUS}. Further, when switch capacitor circuit 1 operates in a first mode, a voltage conversion ratio of an input voltage and an output voltage of switch capacitor circuit 1 may be N:1, and when switch capacitor circuit 1 operates in a second mode, the voltage conversion ratio may be 2:1. Also in the second mode, at least one first switch capacitor unit may be enabled to operate, and, e.g., N is a positive integer greater than or equal to 3.

In this embodiment, N=4, switch capacitor circuit 1 can include three switch capacitor units, and each of the three switch capacitor units can include a first structure, and two second power transistors. The first structure can include a third power transistor, a flying capacitor, and a fourth power transistor connected in series between port o2 and the ground terminal, and the two second power transistors can connect a corresponding first structure. In this embodiment, three first structures 11 to 13 can connect in parallel between port o2 and the ground terminal. Power transistor Q21 can connect between port o2 and structure 11, power transistor Q22 can connect between structure 11 and structure 12, power transistor Q23 can connect between structure 12 and structure 13, and power transistor Q24 can connect between structure 13 and port o1.

Further, structure 11 can include power transistor Q31, flying capacitor C_{FIY1}, and power transistor Q41 connected in series between port o2 and the ground terminal. Structure 12 can include power transistor Q32, flying capacitor C_{FIY2}, and power transistor Q42 coupled in series between port o2 and the ground terminal. Structure 13 can include power transistor Q33, flying capacitor C_{FIY3}, and power transistor Q43 coupled in series between port o2 and the ground terminal. Power transistor Q21 can connect between port o2 and a common node of flying capacitor C_{FIY1} and power transistor Q41 in structure 11. Power transistor Q22 can connect between a common node of power transistor Q31 and flying capacitor C_{FIY1} in structure 11 and a common node of flying capacitor C_{FIY2} and power transistor Q42 in structure 12. Power transistor Q23 can connect between a common node of power transistor Q32 and flying capacitor C_{FIY2} in structure 12 and a common node of power transistor Q43 and flying capacitor C_{FIY3} in structure 13. Power transistor Q24 can connect between power transistor Q33 and flying capacitor C_{FIY3} in structure 13 and port o1.

Here, the i-th switch capacitor unit can include an i-th first structure and two second power transistors adjacent to the i-th first structure, whereby i is less than or equal to N−1. In this example, the first switch capacitor unit can include structure 11 and power transistors Q21 and Q22. The second switch capacitor unit can include structure 12 and power transistors Q22 and Q23. Also, the third switch capacitor unit can include structure 13 and power transistors Q23 and Q24.

The switch capacitor charging circuit can also include at least one first power transistor. A first terminal of each first power transistor can connect to port o1, and a second terminal of each first power transistor can connect to one terminal of a flying capacitor in different switch capacitor unit. In the second mode, at least one switch capacitor unit may receive a voltage of voltage source V_{BUS} through the first power transistor connected thereto, and can generate a voltage of battery B1.

In an embodiment, the switch capacitor charging circuit can also include power transistor Q1, whereby a first terminal of power transistor Q1 can connect to port o1, and the second terminal of power transistor Q1 can connect to one terminal of flying capacitor C_{FIY1} in the first switch capacitor unit. Power transistor Q1 can be controlled to periodically be turned on and off in the second mode, such that the first switch capacitor unit participates in operation, thereby improving the efficiency of the switch capacitor charging circuit. Optionally, the switch capacitor charging circuit and also include switch QB, which can prevent leakage and prevent current from flowing back into voltage source V_{BUS}. In this embodiment, the switch capacitor charging circuit and also include input capacitor Cin to filter an output voltage of voltage source V_{BUS}.

In this example, switch capacitor circuit 1 may be configured as a series-parallel switch capacitor circuit, and the voltage conversion ratio is 4:1. In other embodiments, the switch capacitor circuit 1 can be a switch capacitor converter with other suitable voltage conversion ratios (e.g., 3:1, 5:1, 6:1 etc.). When switch capacitor circuit 1 operates in the first mode, that is, when the voltage conversion ratio of the input voltage and the output voltage is 4:1, N−1 switch capacitor units may all participate in the operation. In this particular example, N=4, that is, all three switch capacitor units participate in the operation, such that voltage V_{BAT} on battery B1 is equal to ¼V_{BUS}. Further, N−1 switch capacitor units can be controlled to switch an operation state, such that flying capacitors in the N−1 switch capacitor units are coupled in one of series and parallel connections between the second port and the first port, in order to charge the first battery.

In particular embodiments, when switch capacitor circuit 1 operates in the first mode, in each switch capacitor unit, the third and fourth power transistors can be controlled by a first control signal, and the second power transistor may be controlled by a second control signal. Here, e.g., a phase difference between the first and second control signals is 180°, and a duty cycle of the first control signal is consistent with (e.g., the same as) that of the second control signal. Further, when switch capacitor circuit 1 operates in the first mode, in a first interval of a switching cycle, the first control signal can be at high level, the second control signal may be at low level, power transistors Q21 to Q24 can be turned on, and power transistors Q31-Q33 and Q41-Q43 may all be turned off. At this time, flying capacitor V_{CFIY1}-V_{CFIY3} and battery B1 can effectively connect in series, and voltage source V_{BUS} can charge flying capacitor V_{CFIY1}-V_{CFIY3} and battery B1, such that voltage source V_{BUS} is equal to a sum of voltages V_{CFIY1}-V_{CFIY3} on three flying capacitors C_{CFIY1}-C_{CFIY3} and voltage V_{BAT} on the first battery; that is:

$${V}_{BUS} = {V}_{CFLY 1} + {V}_{CFLY 2} + {V}_{CFLY 3} + {V}_{BAT} .$$

In a second interval of the switching cycle, the first control signal can be at low level, the second control signal may be at high level, power transistors Q31-Q33 and Q41-Q43 may all be turned on, and power transistors Q21-Q24 may all be turned off. At this time, flying capacitor C_{CFIY1}-C_{CFIY3} can effectively connect in parallel with battery B1, respectively. Therefore, voltages V_{CFIY1}-V_{CFIY3} on three flying capacitors C_{FIY1}-C_{FIY3} may be equal to voltage V_{BAT} on the first battery; that is: V_{CFLY1}=V_{CFLY2}=V_{CFLY3}=V_{BAT}. Accordingly, it can be obtained that voltage V_{BAT} of the first battery is equal to a quarter of voltage source V_{BUS}; that is, V_{BAT}=¼V_{BUS}.

When switch capacitor circuit 1 operates in the second mode; that is, the voltage conversion ratio of the input voltage and the output voltage is 2:1, the first switch capacitor unit may participate in the operation, or the (N−1)-th switch capacitor unit and the first switch capacitor unit can connect in parallel and be enabled to operate together. That is, the third switch capacitor unit and the first switch capacitor unit can connect in parallel to operate, such that voltage V_{BAT} on battery B1 is equal to ½V_{BUS}. The operating process is described below in two operation manners.

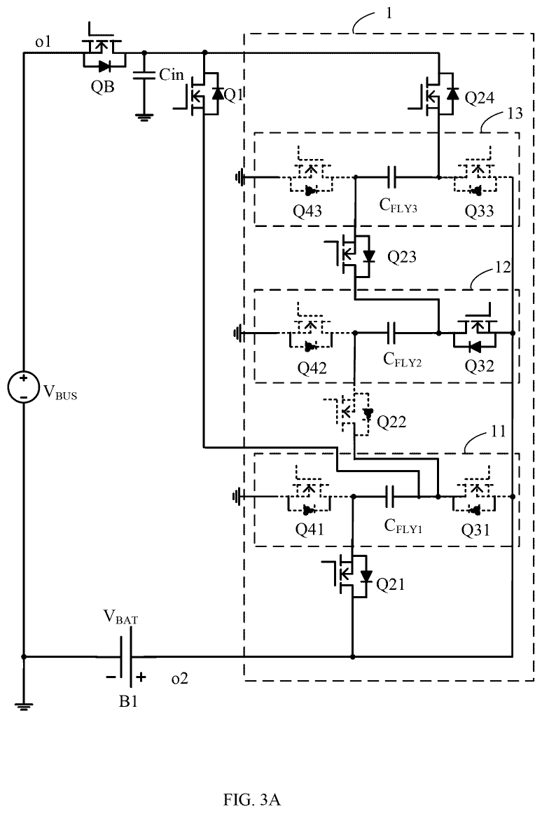

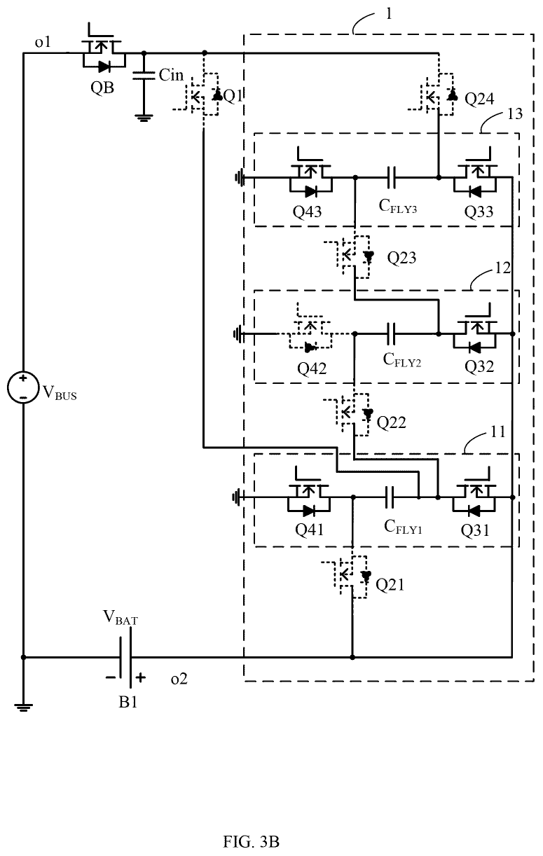

Referring now to FIGS. 3A and 3B, shown are equivalent circuit diagrams of the first example switch capacitor charging circuit with a first operation manner in different operation stages in the second mode, in accordance with embodiments of the present invention. The first operation manner here may refer to that when switch capacitor circuit 1 operates in the second mode, the third switch capacitor unit and the first switch capacitor unit essentially connect in parallel to operate.

Referring to FIG. 3A, in the (N−2)-th switch capacitor unit, the third power transistor may remain in the on state, and the fourth power transistor may remain in the off state. In this example, in the second switch capacitor unit, power transistor Q32 may remain in the on state, and power transistor Q42 may remain in the off state, such that the third switch capacitor unit is directly connected to battery B1. Further, power transistor Q1, structure 11, and power transistor Q21 can form the first switch capacitor unit, such that the first switch capacitor unit is directly connected to voltage source V_{BUS}. Thus, the third switch capacitor unit and the first switch capacitor unit may form a parallel structure, and can connect in parallel between port o1 and the positive terminal of battery B1; that is, port o2.

In one example of, in a first interval, second power transistors Q21, Q23, and Q24 can be turned on, power transistor Q1 may be turned on, third power transistors Q31 and Q33, and power transistor Q41-Q43 can be turned off, and power transistor Q32 may be turned on. Among power transistors Q41-Q43, except power transistor Q32 which may remain on, all other power transistors can be turned off. At this time, a parallel-connection of flying capacitor C_{FIY1} and flying capacitor C_{FIY3} can connect in series with battery B1, and voltage source V_{BUS} can charge flying capacitors C_{FIY1} and C_{FIY3} and battery B1, such that voltage source V_{BUS} is equal to the sum of voltage V_{CFIY3} on flying capacitance C_{FIY3} and voltage V_{BAT} on battery B1. Or, voltage source V_{BUS} is equal to the sum of voltage V_{CFIY1} on flying capacitance C_{FIY1} and voltage V_{BAT} on battery B1; that is: V_{BUS}=V_{CFLY3}+V_{BAT}, V_{BUS}=V_{CFLY1}+V_{BAT}.

Referring to FIG. 3B, in the second interval, among third power transistors Q31-Q33 and fourth power transistors Q41-Q43, all the power transistors can be turned on except power transistor Q42, and power transistor Q1 and all second power transistors Q21-Q24 may be turned off. At this time, flying capacitors C_{FIY1} and C_{FIY3} can connect in parallel with battery B1, respectively, such that voltages on V_{C FIY1} and V_{CFIY3} on flying capacitors C_{FIY1} and C_{FIY3} may respectively be equal to voltage V_{BAT} on battery B1; that is: V_{CFLY1}=V_{CFLY3}=V_{BAT}. Accordingly, can be obtained that voltage V_{BAT} on battery B1 is equal to one half of voltage source V_{BUS}; that is, V_{BAT}=½V_{BUS}.

When the voltage conversion ratio of the input voltage and the output voltage of the switch capacitor charging circuit is 2:1, and when the parameters of the two switch capacitor units are exactly the same, particularly under the premise that the on-resistance of each power transistor is the same, and because the two switch capacitor units connected in parallel operate, on the one hand, under the condition that the output power of the system is constant, the charging current flowing through each of the two switch capacitor units may only need half of the charging current when the original switch capacitor unit operates. When the charging current exceeds a certain lower threshold, the charging efficiency of the system can be inversely related to the charging current. When the charging current is smaller, the charging efficiency may be higher. Therefore, the switch capacitor charging circuit of this particular example can improve the charging efficiency of the system when the voltage conversion ratio of the input voltage and the output voltage is 2:1. On the other hand, if the charging current flowing through each of the two switch capacitor units is constant, which is equal to the charging current of the original switch capacitor unit, the charging current of the load can be doubled by using this approach, and the output power of the system can be doubled without considering other effects.

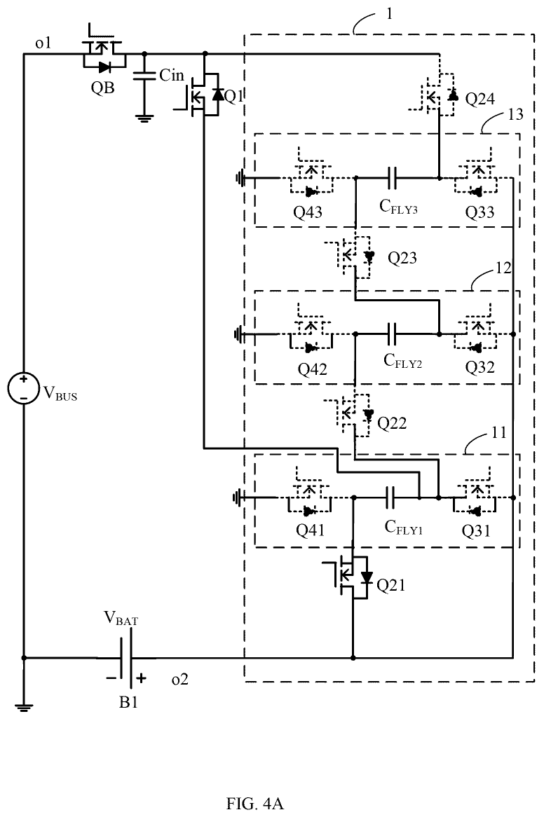

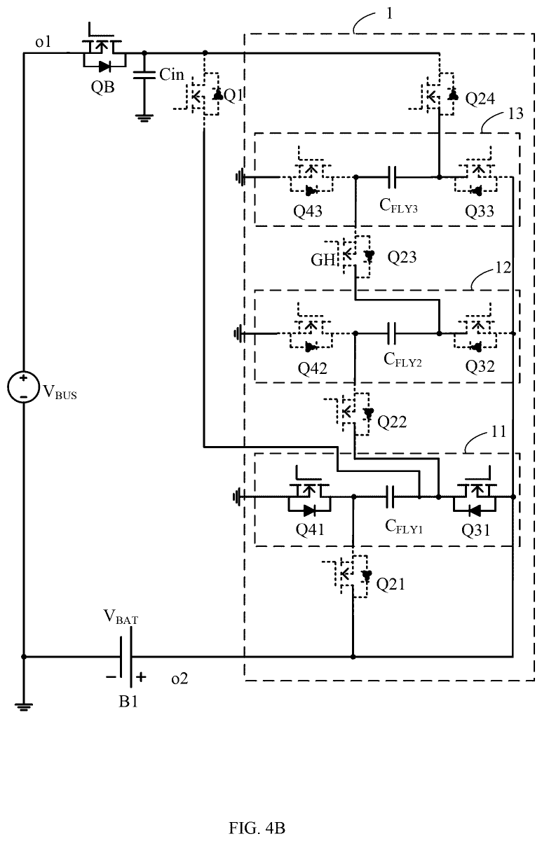

Referring now to FIGS. 4A and 4B, shown are equivalent circuit diagrams of the first example switch capacitor charging circuit with a second operation manner in different operating stages in the second mode, in accordance with embodiments of the present invention. The second operation manner here may refer to that when switch capacitor circuit 1 operates in the second mode, and only the first switch capacitor unit participates in the operation.

Referring to FIG. 4A, the first switch capacitor unit can include power transistor Q1, structure 11, and power transistor Q21, such that the first switch capacitor unit is directly connected to voltage source V_{BUS}. Thus, the first switch capacitor unit can connect between port o1 and a positive terminal of battery B1; that is, port o2, and can participate in the operation alone. For example, in the first interval, power transistors Q21 and Q1 can be turned on, and all other power transistors may be turned off. At this time, flying capacitor C_{FIY1} can connect in series with battery B1, and voltage source V_{BUS} can charge flying capacitor C_{FIY1} and battery B1, such that first voltage source V_{BUS} is equal to the sum of voltage V_{CFIY1} on flying capacitance C_{FIY1} and voltage V_{BAT} on battery B1; that is: V_{BUS}=V_{CFLY1}+V_{BAT};

Referring to FIG. 4B, in the second interval, power transistors Q31 and Q41 can be turned on, and power transistor Q1 and all other power transistors may be turned off. At this time, flying capacitors C_{FIY1} can connect in parallel with battery B1, such that voltage V_{CFIY1} on flying capacitance C_{FIY1} is equal to voltage V_{BAT} on the first battery; that is: V_{CFLY1}=V_{BAT}. Accordingly, it can be obtained that: voltage V_{BAT} on the first battery is equal to one half of first voltage source V_{BUS}; that is, V_{BAT}=½V_{BUS}.

When the voltage conversion ratio of the input voltage and the output voltage of the switch capacitor charging circuit is 2:1, because only the first switch capacitor unit near the low voltage side of the first voltage source is involved in the operation, in the design of the switch capacitor charging circuit, in order to balance the area of the chip, the on-resistance of the power transistor near the high voltage side of the first voltage source can be higher than that of the power transistor near the low voltage side of the first voltage source. For example, the on-resistance of power transistors Q33 and Q43 may be higher than that of power transistors Q31 and Q41. Therefore, the switching loss of the power transistor in the first switch capacitor unit can be lower than that of the power transistor in the third switch capacitor unit. As such, with a reasonable on-resistance value of power transistor Q1, the efficiency of the switch capacitor charging circuit can be improved.

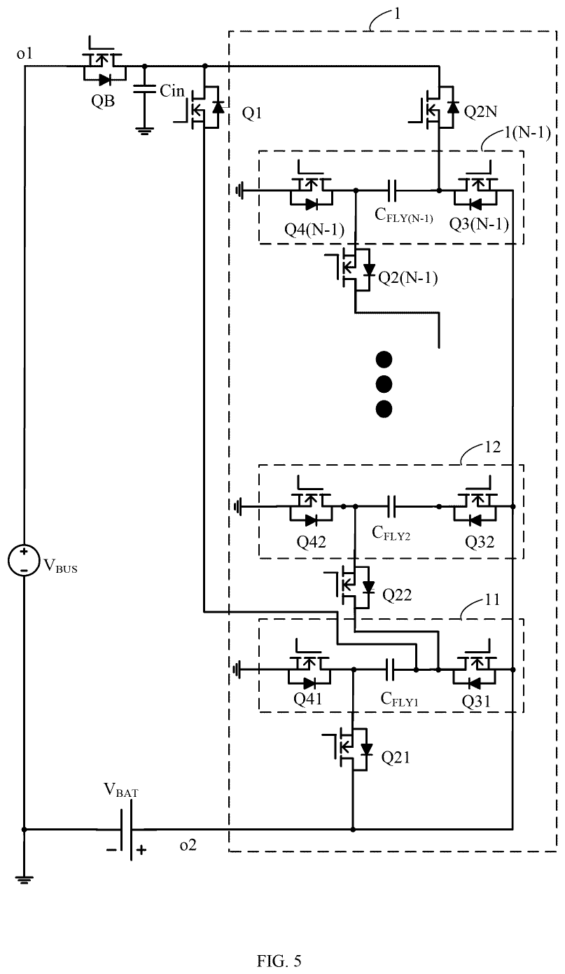

Referring now to FIG. 5, shown is a schematic block diagram of a second example switch capacitor charging circuit, in accordance with embodiments of the present invention. In this particular example, switch capacitor circuit 1 can include N−1 switch capacitor units connected in series and parallel. When switch capacitor circuit 1 operates in the first mode, the voltage conversion ratio can be N:1. When switch capacitor circuit 1 operates in the second mode, the voltage conversion ratio may be 2:1, and at least one switch capacitor unit participates in the operation, whereby N is a positive integer greater than or equal to 3.

In particular embodiments, switch capacitor circuit 1 can include switch capacitor units, and each switch capacitor unit can include a first structure and two second power transistors. Structures 11-1 (N−1) can be coupled in parallel between port o2 and the ground terminal, whereby each first structure can include at least two power transistors and a flying capacitor. In this example, power transistor Q21 can connect between port o2 and structure 11, power transistor Q2i can connect between a (i−1)-th structure 1(i−1) N and an i-th structure 1iN, and power transistors Q2N can connect between a (N−1)-th first structure 1(N−1) and port o1, where 2≤i≤N−1. The switch capacitor charging circuit can include power transistor Q1, a first terminal of power transistor Q1 can connect to port o1 through switch QB, and a second terminal of power transistor Q1 can connect to a common terminal of flying capacitor C_{FIY1} and power transistor Q31 in the first switch capacitor unit. It should be understood that power transistor Q1 can connect to one terminal of a flying capacitor in any one of a first to a (N−2)-th switch capacitor units, in certain embodiments.

In addition, structure 1k can include power transistor Q3k, flying capacitor C_{FIYk}, and power transistor Q4k connected in series between port o2 and the ground terminal. Power transistor Q21 can connect between port o2 and a common node of flying capacitor C_{FIY1} and power transistor Q41 in structure 11. Power transistor Q2i can connect between a common node of power transistor Q3(i−1) and flying capacitor C_{FIY}(i−1) in structure 1(i−1) and a common node of flying capacitor C_{FIYi} and power transistor Q4i in structure 1i, where 2≤i≤N−1. Power transistor Q2N can connect between a common node of third power transistor Q3(N−1) and flying capacitor C_{FIY}(N−1) in structure 1(N−1) and port o1. A k-th switch capacitor unit can include k-th structure 1k, power transistor Q2k, and power transistor Q2(k+1) adjacent to k-th structure 1k, whereby k is a positive integer less than or equal to N−1.

When switch capacitor circuit 1 operates in a first mode, that is, when the voltage conversion ratio of the input voltage and the output voltage is N:1, N−1 switch capacitor units may all participate in the work, such that voltage V_{BAT} on battery B1 is equal to 1/NV_{BUS}. When switch capacitor circuit 1 operates in a second mode; that is, the voltage conversion ratio of the input voltage and the output voltage is 2:1, at least one switch capacitor unit can receive a voltage of voltage source V_{BUS} through the first transistor coupled to thereto, and may generate a voltage of the first battery. In this example, the first switch capacitor unit can participate in the work, or the (N−1)-th switch capacitor unit and the first switch capacitor unit can connect in parallel and are enabled to operate together, such that voltage V_{BAT} on battery B1 is equal to ½V_{BUS}.

When N is greater than or equal to 4, and switch capacitor circuit 1 operates in the second mode in which the voltage conversion ratio between the input voltage and the output voltage is 2:1, only the first switch capacitor unit may participate in the work, or the (N−1)-th switch capacitor unit and the first switch capacitor unit can connect in parallel to operate together. When the first switch capacitor unit participates in work, power transistor Q1, structure 11, and power transistor Q21 may form the first switch capacitor unit. When the (N−1)-th switch capacitor unit and the first switch capacitor unit connect in parallel and participate in the work together, power transistor Q3 (N−2) may remain in the on state and power transistor Q4 (N−2) may remain in the off state in the (N−2)-th switch capacitor unit, such that the (N−1)-th switch capacitor unit and the first switch capacitor unit form a parallel connection structure.

When N equals 3, there are only two switch capacitor units, and the two switch capacitor units may not form a parallel connection structure. Thus, when switch capacitor circuit 1 operates in the second mode, only the first switch capacitor unit may participate in work. By adding at least one first power transistor, three power transistors on a low-voltage side of the first voltage source, a flying capacitor and the first power transistor may form at least one switch capacitor unit with the voltage conversion ratio of 2:1, which can connect in parallel with a switch capacitor unit with the voltage conversion ratio of 2:1 on a high-voltage side of the first voltage source. In this way, when the voltage conversion ratio of the input voltage and the output voltage is 2:1 in the second mode, the charging current and power can be improved, and the efficiency increased.

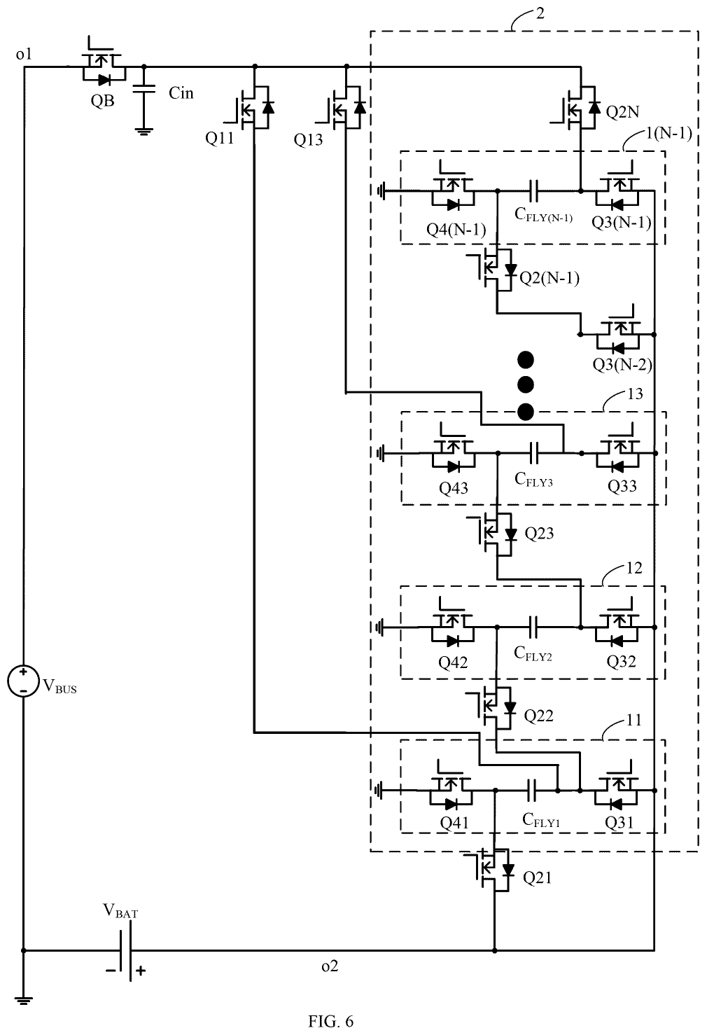

Referring now to FIG. 6, shown is a schematic block diagram of a third example switch capacitor charging circuit, in accordance with embodiments of the present invention. In this particular example, when switch capacitor circuit 2 operates in the second mode, any one of the N−1 switch capacitor units may participate in the operation, whereby N is a positive integer greater than or equal to 3. Switch capacitor circuit 2 can include N−1 switch capacitor units, and each switch capacitor unit can include one a first structure and two power transistors. Structures 11-1 (N−1) can be coupled in parallel between port o2 and the ground terminal, whereby each first structure can include at least two power transistors and a flying capacitor. In this example, power transistor Q21 can connect between port o2 and structure 11, power transistor Q2i can connect between a (i−1)-th structure 1(i−1) N and a i-th structure 1iN, and power transistors Q2N can connect between a (N−1)-th first structure 1(N−1) and port o1, whereby 2≤i≤N−1.

The switch capacitor charging circuit can include at least one first power transistor, whereby a first terminal of each first power transistor is coupled to the first port, and a second terminal of each first power transistor is coupled to one terminal of a flying capacitor in a different switch capacitor unit. Thus, in the second mode, the at least one switch capacitor unit can receive a voltage of the first voltage source through a first transistor coupled to thereto, and may generate a voltage of the first battery.

In one embodiment, in the second mode, at least one switch capacitor unit in a first to a (N−2)-th switch capacitor units can be coupled in parallel with the (N−1)-th switch capacitor unit to operate, and may receive a voltage of the first voltage source through a first transistor coupled to thereto, and generate a voltage of the first battery.

In one embodiment, in the second mode, at least one switch capacitor unit in a first to a (N−2)-th switch capacitor units can be coupled in parallel with the (N−1)-th switch capacitor unit to operate, may receive a voltage of the first voltage source through a first power transistor coupled to thereto, and can generate a voltage of the first battery. In addition, the (N−1)-th switch capacitor unit may receive a voltage of the first voltage source through second power transistor Q2N, and generate a voltage of the first battery.

In one embodiment, in the second mode, at least two switch capacitor unit in a first to a (N−2)-th switch capacitor units can be coupled in parallel to operate, may receive a voltage of the first voltage source through a first transistor coupled to thereto, and can generate a voltage of the first battery.

In one embodiment, in the second mode, at least one switch capacitor unit in a first to a (N−2)-th switch capacitor units can be coupled in parallel to operate, may receive a voltage of the first voltage source through a first transistor coupled to thereto, and can generate a voltage of the first battery. For example, the switch capacitor unit with a lower serial number can have priority to operate, in order to reduce switching losses.

In one embodiment, in the second mode, when any one of the switch capacitor units is enabled to operate, in a first interval of a switching cycle, a flying capacitor in a corresponding switch capacitor unit can be coupled in series with the first battery between the first port and a ground terminal. Also, in a second interval of a switching cycle, the flying capacitor in the corresponding switch capacitor unit may be coupled in parallel between the second port and the ground terminal.

In one embodiment, in the second mode, when an i-th switch capacitor unit is enabled to operate, in a first interval of a switching cycle, a first power transistor coupled to the i-th switch capacitor unit can be turned on, a second power transistor coupled between the i-th switch capacitor unit and an (i−1)-th switch capacitor unit may be turned on, and a third power transistor in the (i−1)-th switch capacitor unit can be turned on. Also, in a second interval of a switching cycle, third and fourth power transistors in the i-th switch capacitor unit can be turned on, whereby 2≤i≤N−2.

In the second mode, when the first switch capacitor unit is enabled to operate, in a first interval of a switching cycle, a first power transistor coupled to the first switch capacitor unit can be turned on, and a second power transistor coupled between the first switch capacitor unit and the second port may be turned on. Also, in a second interval of a switching cycle, third and fourth power transistors in the first switch capacitor unit can be turned on. In the second mode, when the (N−1)-th switch capacitor unit is enabled to operate, in a first interval of a switching cycle, two second power transistor coupled in the (N−1)-th switch capacitor unit can be turned on, and a third power transistor in an (N−2)-th switch capacitor unit may be turned on. Also, in a second interval of a switching cycle, third and fourth power transistors in the (N−1)-th switch capacitor unit can be turned on.

In this embodiment, the switch capacitor charging circuit can include two first power transistors Q11 and Q13. A first terminal of power transistor Q11 can be coupled to port o1 through switch QB, and a second terminal of power transistor Q11 may be coupled to a common terminal of flying capacitor C_{FIY1} and power transistor Q31 in the first switch capacitor unit. A first terminal of power transistor Q13 can be coupled to port o1 through switch QB, and a second terminal of power transistor Q13 may be coupled to a common terminal of flying capacitor C_{FIY3} and power transistor Q33 in the third switch capacitor unit. In this way, at least one of the first, the third, and the (N−1)-th switch capacitor units can operate in the second mode, in order to achieve the voltage conversion ratio of 2:1. In one embodiment, in the second mode, the first switch capacitor unit can connect in parallel with the (N−1)-th switch capacitor unit to operate.

In one embodiment, in the second mode, switch capacitor unit 13 and the (N−1)-th switch capacitor unit can connect in parallel for operation. In a first interval of a switching cycle, power transistor Q13 connected to switch capacitor unit 13 may be turned on, power transistor Q23 connected between the second and third switch capacitor units can be turned on, and power transistor Q32 connected to the second switch capacitor unit may be turned on, such that flying capacitor C_{FIY3} and battery B1 can connect in series between port o1 and the ground terminal. In addition, two power transistors Q2N and Q2(N−1) may be turned on, as well as power transistor Q3(N−2) in the (N−2)-th switch capacitor unit 1(N−2), such that flying capacitor C_{FIY(N-1)} and battery B1 can connect in series between port o1 and the ground terminal. In a second interval of a switching cycle, third and fourth power transistors in the (N−1)-th and the third switch capacitor units can be turned on, such that flying capacitor C_{FIY(N-1)} and battery B1 can connect in parallel between port o2 and the ground terminal, and flying capacitor C_{FIY3} and battery B1 can connect in parallel between port o2 and the ground terminal.

In one embodiment, in the second mode, switch capacitor unit 13 and switch capacitor unit 11 can connect in parallel for operation. In a first interval of a switching cycle, power transistor Q13 connected to switch capacitor unit 13 can be turned on, power transistor Q23 connected between the second and third switch capacitor unit 13 may be turned on, and power transistor Q32 connected to switch capacitor unit can be turned on, such that flying capacitor C_{FIY3} and battery B1 can connect in series between port o1 and the ground terminal. In addition, power transistor Q11 connected to switch capacitor unit 11 may be turned on, and power transistor Q21 connected between port o2 and switch capacitor unit 11 can be turned on, such that flying capacitor C_{FIY1} and battery B1 can connect in series between port o1 and the ground terminal. In a second interval of a switching cycle, third and fourth power transistors in the first and third switch capacitor units can be turned on, such that flying capacitor C_{FIY3} and battery B1 can connect in parallel between port o2 and the ground terminal, and flying capacitor C_{FIY1} and battery B1 can connect in parallel between port o2 and the ground terminal.

In this embodiment, when the switch capacitor charging circuit operates in the second mode, at least one switch capacitor unit can receive a voltage of the first voltage source through a first transistor coupled to thereto, and can generate a voltage of the first battery, thereby improving the charging current and power, and improving efficiency of the switch capacitor charging circuit.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A switch capacitor charging circuit, comprising:
a) a first port coupled to a first voltage source;
b) a second port coupled to a first battery;
c) a switch capacitor circuit comprising (N−1) switch capacitor units coupled between the first port and the second port, and being configured to charge the first battery, wherein each of the switch capacitor units comprises a flying capacitor;
d) at least one first power transistor, wherein each first power transistor comprises a first terminal coupled to the first port, and a second terminal coupled to one terminal of a flying capacitor in a different switch capacitor unit; and
e) wherein the first switch capacitor unit is coupled to the second port, and an (N−1)-th switch capacitor unit is configured to be coupled to the first port, wherein N is a positive integer greater than or equal to 3.

2. The switch capacitor charging circuit of claim 1, wherein:
a) when the switch capacitor charging circuit operates in a first mode, a voltage conversion ratio of an input voltage and an output voltage is N:1;
b) when the switch capacitor charging circuit operates in a second mode, the voltage conversion ratio is 2:1; and
c) when in the second mode, at least one switch capacitor unit is enabled to operate.

3. The switch capacitor charging circuit of claim 2, wherein in the second mode, the at least one switch capacitor unit is configured to receive a voltage of the first voltage source through a first transistor coupled to thereto, and to generate a voltage of the first battery.

4. The switch capacitor charging circuit of claim 2, wherein in the second mode, at least one switch capacitor unit in a first to a (N−2)-th switch capacitor units are coupled in parallel with the (N−1)-th switch capacitor unit to operate, and configured to receive a voltage of the first voltage source through a first power transistor coupled to thereto, and to generate a voltage of the first battery.

5. The switch capacitor charging circuit of claim 2, wherein in the second mode, at least two switch capacitor unit in a first to a (N−2)-th switch capacitor units are coupled in parallel to operate, and configured to receive a voltage of the first voltage source through a power first transistor coupled to thereto, and to generate a voltage of the first battery.

6. The switch capacitor charging circuit of claim 2, wherein in the first mode, when the switch capacitor circuit operates in the first mode, the N−1 switch capacitor units are all enabled to operate.

7. The switch capacitor charging circuit of claim 1, wherein in the second mode, at least the first switch capacitor unit is configured to receive a voltage of the first voltage source through a first power transistor coupled to thereto, and to generate a voltage of the first battery.

8. The switch capacitor charging circuit of claim 1, wherein the N−1 switch capacitor units are controlled to switch an operation state, such that flying capacitors in the N−1 switch capacitor units are coupled in one of series and parallel connections between the second port and the first port, in order to charge the first battery.

9. The switch capacitor charging circuit of claim 2, wherein each switch capacitor unit comprises:
a) a first structure comprising a third power transistor, a flying capacitor, and a fourth power transistor connected in series between the second port and the ground terminal; and
b) two second power transistors, wherein each of the two second power transistors is coupled to the first structure.

10. The switch capacitor charging circuit of claim 2, wherein:
a) in the second mode, when any one of the switch capacitor units is enabled to operate, in a first interval of a switching cycle, a flying capacitor in a corresponding switch capacitor unit is coupled in series with the first battery between the first port and a ground terminal; and
b) in a second interval of a switching cycle, the flying capacitor in the corresponding switch capacitor unit is coupled in parallel between the second port and the ground terminal.

11. The switch capacitor charging circuit of claim 9, wherein:
a) in the second mode, when an i-th switch capacitor unit is enabled to operate, in a first interval of a switching cycle, a first power transistor coupled to the i-th switch capacitor unit is turned on, a second power transistor coupled between the i-th switch capacitor unit and a (i−1)-th switch capacitor unit is turned on, and a third power transistor in the (i−1)-th switch capacitor unit is turned on; and
b) in a second interval of a switching cycle, third and fourth power transistors in the i-th switch capacitor unit are turned on, wherein 2≤i≤N−2.

12. The switch capacitor charging circuit of claim 9, wherein:
a) in the second mode, when the first switch capacitor unit is enabled to operate, in a first interval of a switching cycle, a first power transistor coupled to the first switch capacitor unit is turned on, and a second power transistor coupled between the first switch capacitor unit and the second port is turned on; and
b) in a second interval of a switching cycle, third and fourth power transistors in the first switch capacitor unit are turned on.

13. The switch capacitor charging circuit of claim 9, wherein:
a) in the second mode, when the (N−1)-th switch capacitor unit is enabled to operate, in a first interval of a switching cycle two second power transistor coupled in the (N−1)-th switch capacitor unit are turned on, and a third power transistor in a (N−2)-th switch capacitor unit is turned on; and
b) in a second interval of a switching cycle, third and fourth power transistors in the (N−1)-th switch capacitor unit are turned on.

14. The switch capacitor charging circuit of claim 9, wherein:
a) in the first mode, in each switch capacitor unit, third and fourth power transistors are controlled by a first control signal, and each second power transistor is controlled by a second control signal; and
b) a phase difference between the first and second control signals is 180°, and a duty cycle of the first control signal is consistent with that of the second control signal.

15. The switch capacitor charging circuit of claim 1, further comprising a switch coupled between the first port and the switch capacitor circuit, wherein the switch is configured to prevent a current from flowing back into the first voltage source.
